(19) United States
(12) Patent Application Publication
(10) Pub. No.: US 2014/0222446 A1
(43) Pub. Date: Aug. 7, 2014

(54) REMOTE PATIENT MONITORING SYSTEM

(71) Applicant: CERNER INNOVATION, INC., LENEXA, KS (US)

(72) Inventors: MICHAEL ALAN ASH, PARKVILLE, MO (US); BRIAN R. CARTER, KANSAS CITY, MO (US)

(73) Assignee: CERNER INNOVATION, INC., LENEXA, KS (US)

(21) Appl. No.: 13/761,704

(22) Filed: Feb. 7, 2013

(51) Int. Cl. G06F 19/00; G06Q 50/22

(52) U.S. Cl. CPC G06F 19/3406; G06Q 50/22
USPC 705/2

(57) ABSTRACT

Methods, computer systems, and computer storage media are provided for remotely monitoring health metrics for a patient. An indication of health metrics to monitor for the patient and information related to the health metrics is received. The criticality of each health metric is determined based on recognizing that the information associated with each health metric falls into a predetermined range of values that are associated with a defined criticality for the health metric. A health alert status is assigned to each of the health metrics based on the determined criticalities. If the information related to the health metric indicates that the health metric has reached a predefined level of criticality, an alert is provided to a healthcare provider associated with the patient. The health alert status is presented on a graphical user interface.

### BACKGROUND

Efforts to reduce healthcare costs, alleviate staffing constraints within healthcare facilities, and provide better care for patients have led to an increase in the use of remote patient monitoring devices. Remote patient monitoring devices allow patients to independently monitor a variety of health metrics, such as blood glucose or blood pressure. In this way, remote patient monitoring can drastically improve healthcare outcomes for patients by informing patients of their health metric values on a more frequent and convenient basis.

Despite the many benefits of remote patient monitoring devices, healthcare providers are currently unable to customize the type and frequency of health metric information they receive from such devices. Most data received from monitoring devices is condition-specific (i.e., it relates to a condition, such as diabetes). However, patients are typically unique across a variety of health factors, such as, for example, age, gender, type and severity of disease, and genetic history. Condition-specific monitoring does not take into account such patient-specific factors. As a result, healthcare providers may underestimate or overestimate the significance of remotely-monitored health metric information for different patients. Thus, improvements in remote patient monitoring are still needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer storage media for remotely monitoring health metrics for a patient. Initially, a healthcare provider logs in to a patient profile that stores and presents information about remotely-monitored health metrics for a patient. Within the patient profile, the healthcare provider can customize monitoring parameters for the patient's health metrics by inputting monitoring information into the patient profile. Exemplary monitoring information includes a frequency of monitoring, a type of health metric to be monitored, a number of health metrics to monitor, reference values used to determine a criticality of a health metric, and conditions under which alerts should be communicated to one or more healthcare providers, the patient, or other third parties consented to by the patient.

As well, health metric information (e.g., values measured for the health metric) is received at the patient profile from at least one remote monitoring device associated with the patient. A criticality of health metrics being monitored for the patient is determined based on recognizing that the information associated with each health metric falls into one of the customized reference values already associated with a defined criticality for the health metric. The criticality determination is used to assign a health alert status to each health metric for the patient and/or to communicate an alert to a healthcare provider. If a patient's health metric reaches a predefined criticality level, an alert may be communicated to at least one of the patient's healthcare providers. In this way, customized alerts may carry special significance to healthcare providers, potentially leading to quicker response times and more effective care.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a system diagram of an exemplary system for remotely monitoring one or more health metrics for a patient suitable to implement embodiments of the present invention;

FIG. 3 depicts an exemplary graphical user interface illustrating a presentation of health alert statuses for a plurality of patients according to an embodiment of the present invention;

FIG. 4 depicts an exemplary graphical user interface for selecting health metrics to monitor for a patient according to an embodiment of the present invention;

FIG. 5 depicts an exemplary graphical user interface for predetermining criticality and frequency parameters for a health metric that is to be monitored according to an embodiment of the present invention;

FIG. 6 depicts an exemplary graphical user interface for displaying summarized health metric information according to an embodiment of the present invention;

FIG. 7 depicts a flow diagram illustrating a method for determining a criticality of health metrics and assigning health alert statuses to the health metrics according to an embodiment of the present invention; and

FIG. 8 depicts a flow diagram illustrating a method for alerting one or more healthcare providers that a health metric has reached a predefined level of criticality according to an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, computer systems, and computing storage media for remotely monitoring health metrics for a patient. Initially, a healthcare provider logs in to a patient profile that stores and presents information about remotely-monitored health metrics for a patient. Within the patient profile, the healthcare provider can customize monitoring parameters for the patient's health metrics by inputting monitoring information into the patient profile. Exemplary monitoring information includes a frequency of monitoring, a type of health metric to be monitored, a number of health metrics to monitor, reference values used to determine a criticality of a health metric, and conditions under which alerts should be communicated to one or more healthcare providers, the patient, or other third parties consented to by the patient.

As well, health metric information (e.g., values measured for the health metric) is received at the patient profile from at least one remote monitoring device associated with the patient. A criticality of health metrics being monitored for the patient is determined based on recognizing that the information associated with each health metric falls into one of the customized reference values already associated with a defined criticality for the health metric. The criticality determination is used to assign a health alert status to each health metric for the patient and/or to communicate an alert to a healthcare provider. If a patient's health metric reaches a predefined criticality level, an alert may be communicated to at least one of the patient's healthcare providers. In this way, customized alerts may carry special significance to healthcare providers, leading to potentially quicker response times and more effective care.

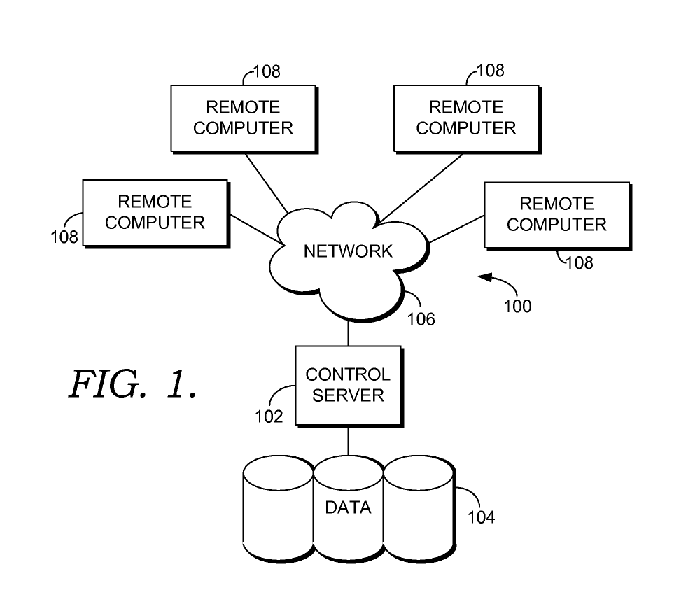

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise non-transitory computer storage media and communication media. Non-transitory computer storage media includes both volatile and nonvolatile, removable and non-removable media implemented in any method or technology for storage of information such as computer-readable instructions, data structures, program modules or other data. Non-transitory computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

The remote patient monitoring system computing environment 200 includes a data store 204, a remote patient monitoring system 206, and a computing device 208, all in communication with one another via a network 202. The network 202 may include, without limitation, one or more secure local area networks (LANs) or wide area networks (WANs). The network 202 may be a secure network associated with a facility such as a healthcare facility. The secure network 202 may require that a user log in and be authenticated in order to send and/or receive information over the network 202.

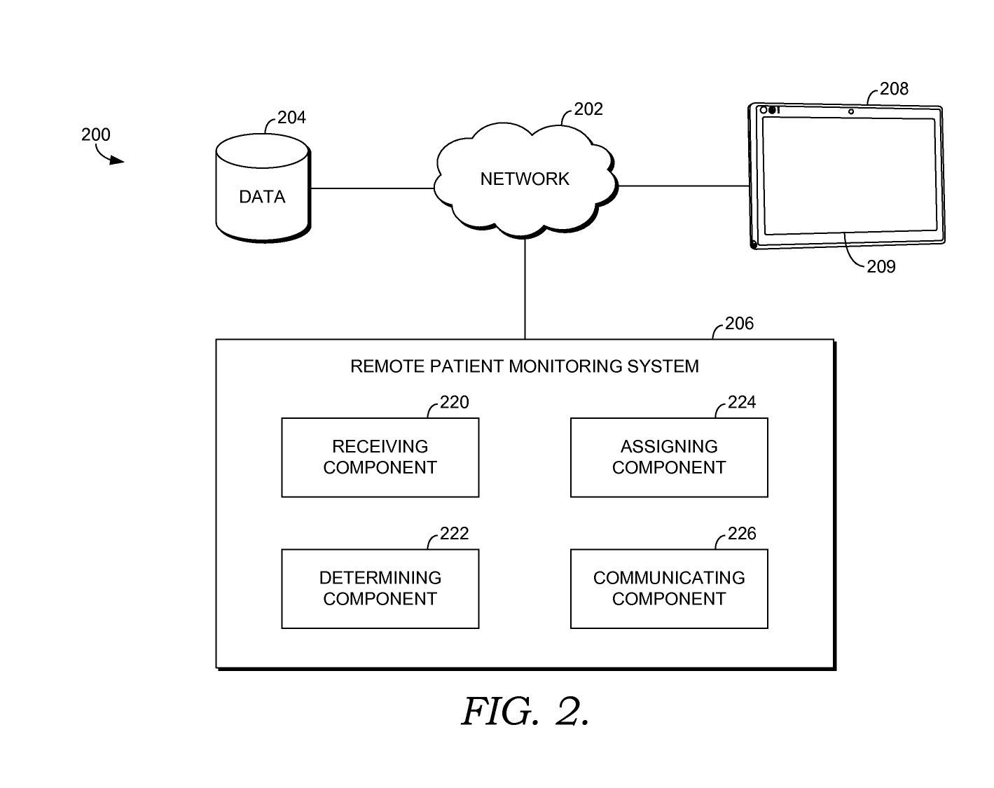

In some embodiments, one or more of the illustrated components/modules may be implemented as stand-alone applications. In other embodiments, one or more of the illustrated components/modules may be integrated directly into the operating system of the remote patient monitoring system 206. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the remote patient monitoring system 206 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 204 is configured to store information for use by, for example, the remote patient monitoring system 206 and/or the computing device 208. The information stored in association with the data store 204 is configured to be searchable for one or more items of information stored in association therewith. The information stored in association with the data store 204 may comprise general information used by the remote patient monitoring system 206 and/or the computing device 208.

The data store 204 may store electronic medical records (EMRs) of patients associated with one or more healthcare facilities. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

Additionally, the data store 204 may store information concerning healthcare providers, patients, health metrics, and alert protocols. Healthcare providers can include physicians, health coaches, registered nurses, aids, respiratory therapists, physical therapists, occupational therapists, or the like. Information concerning healthcare providers may include identifying information for the providers, identifying information for patients who receive care from the providers, types of providers, work history, order history, and the like. Patients can refer to past, current and future patients that remotely monitor their health information using the remote patient monitoring system 206. Information about the patients may include identifying information, health metrics that are being monitored for the patient and/or other information stored in a patient EMR, as described above.

Health metric information includes information relating to one or more health metrics, such as health metric values, devices used to measure health metrics, the criticality of health metrics, the number and type of health metrics monitored for particular patients, and the like. A health metric may be generally defined as a measurement by which the efficiency or proper functioning of an organ, body part, body system, and/or the overall health of a patient is determined. As used throughout, the term “health metric value” generally refers to a qualitative (e.g., “elevated,” “low,” “normal,” etc.) or a quantitative (e.g., a numerical value) value describing a health metric, such as, for example, a blood pressure value, blood sugar glucose values, a weight value, a saturation of hemoglobin value, and the like. A health metric value may also be used to describe other physical or mental qualities about a patient, such as, for example, the number of steps a patient takes in a day. Health metric values may describe multiple conditions of the patient. For instance, the number of steps a patient takes in a day can provide insight into not only the patient's recovery from a knee surgery, but also the extent to which the patient may be depressed.

The criticality of a health metric is defined as the severity of or the degree to which a health metric value may be dangerous or detrimental to a patient's health. The criticality of health metric values may be determined based on the extent to which a health metric value is considered normal or abnormal according to medically-acceptable standards, promulgated by, for instance, nationally-recognized medical institutions, organizations and associations. The criticality of health metric values also may be predefined based on provider-selected reference values inputted into a patient profile and associated with a defined criticality for the health metric. The reference values also may be associated with alerts. For example, if a patient's blood pressure health metric reaches a critical reference value (e.g., 160/120) as predefined by the patient's healthcare provider, an alert may be sent to the healthcare provider.

Alert protocol information includes algorithms or other computational methods for communicating an alert to a healthcare provider, patient, family member of a patient, or other suitable or interested parties when a patient's health metric reaches a predefined level of criticality (i.e., a level that the healthcare provider has predetermined to necessitate an alert). A user, such as, for example, a healthcare provider may define the alert protocols. As well, default protocols may be stored in the data store 204.

The data store 204 also may store patient profile information. Patient profile information is any information received by the remote patient monitoring system 206 and stored in a patient's profile. The information may include, for example, measured health metric values and summarized information about health metric values, such as graphs, charts, statistics, health alert statuses, follow-ups, patient-identifying information, or the like Likewise, the data store 204 can store information about trends and variances for health metrics. Such information might also include one or more of the following: criticality-determining reference values, names or identifiers associated with non-compliant patients, frequencies of health metric monitoring, care teams, alerts, responses to alerts, documentation in an EMR or patient profile, health metric goals, and the like. In one embodiment, the patient profile is password-protected, and the login information for persons having access to a patient's particular profile may also be stored in the data store 204. Additionally, patient consent is required for persons gaining access to a patient profile, and consent information may be stored.

The content and volume of such information in the data store 204 are not intended to limit the scope of embodiments of the present invention in any way. Further, though illustrated as a single, independent component, the data store 204 may, in fact, be a plurality of storage devices, for instance, a database cluster, portions of which may reside on the remote patient monitoring system 206, the computing device 208, and/or any combination thereof.

As shown, the computing device 208 includes a display monitor 209. The display monitor 209 is configured to present information to the user of the computing device 208, such as information relevant to communications initiated and/or received by the end-user computing device 208, information concerning graphical representations of health metric values, information concerning the selection of health metrics to monitor and/or the like. Embodiments are not intended to be limited to visual display but rather may also include audio presentation, combined audio/visual presentation, and the like. The end-user computing device 214 may be any type of display device suitable for presenting a graphical user interface. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions. The tablet PC might have capabilities such as, for example, portability, a flat touch screen display (i.e., the display monitor 209), a Web browser, an accelerometer, ambient light and proximity sensors, microphones, and cameras. Embodiments are not intended to be limited to visual display but rather may also include audio presentation, combined audio/visual presentation, and the like.

Components of the remote patient monitoring system 206 and the computing device 208 may include a processing unit, internal system memory, and a suitable system bus for coupling various system components, including one or more data stores for storing information (e.g., files and metadata associated therewith). The remote patient monitoring system 206 and the computing device 208 typically include, or have access to, a variety of computer-readable media.

The computing system environment 200 is merely exemplary. While the remote patient monitoring system 206 is illustrated as a single unit, it will be appreciated that the remote patient monitoring system 206 is scalable. For example, the remote patient monitoring system 206 may in actuality include a plurality of computing devices in communication with one another. Moreover, the data store 204, or portions thereof, may be included within, for instance, the remote patient monitoring system 206 and the computing device 208 as a computer-storage medium. The single unit depictions are meant for clarity, not to limit the scope of embodiments in any form.

As shown in FIG. 2, the remote patient monitoring system 206 comprises a receiving component 220, a determining component 222, an assigning component 224, and an alerting component 226. In some embodiments, one or more of the components 220, 222, 224, and 226 may be implemented as stand-alone applications. In other embodiments, one or more of the components 220, 222, 224, and 226 may be integrated directly into the operating system of a computing device such as the remote computer 108 of FIG. 1 or the computing device 208. It will be understood that the components 220, 222, 224, and 226 illustrated in FIG. 2 are exemplary in nature and in number and should not be construed as limiting. Any number of components may be employed to achieve the desired functionality within the scope of embodiments hereof.

The receiving component 220 is configured to receive customizable monitoring information from, for example, a healthcare provider. Monitoring information may include an indication of the health metrics to monitor for a patient. In this way, if a patient is measuring multiple health metrics, the patient's healthcare provider may select to monitor all or fewer of the patient's measured health metrics. For instance, the patient's endocrinologist might need to monitor only the patient's blood sugar, whereas the patient's cardiologist might need to monitor only the patient's blood pressure. The endocrinologist and cardiologist could make selections from within the patient profile to monitor only the respective health metric information relevant to their practice. Such information may also include the frequency at which a health metric should be monitored. For example, a provider might request that a blood pressure health metric be monitored on a daily basis while a different health metric, such as weight, be monitored on a weekly basis because of the greater likelihood that a patient's blood pressure values might be variable. Similarly, a healthcare provider may select to monitor at a higher frequency the blood glucose levels for a patient with highly variable blood glucose than the blood glucose levels for a patient with historically stable blood glucose. While the monitoring information is customizable, it will be understood that the receiving component 220 is configured to receive default instructions for monitoring health metrics (e.g., selecting to monitor every health metric at a default frequency for which a patient has been assigned a remote monitoring device).

In one embodiment, the receiving component 220 can receive monitoring information that includes goal values for health metrics. For example, if a healthcare provider wants a patient to lose weight, the healthcare provider can input a goal weight into the patient's health monitoring profile. The progression of the patient toward reaching the goal value may be determined by the determining component 222, as described below. Additionally, the healthcare provider can specify a time in which to reach a goal value. Goal values may also be inputted by a healthcare provider as a set of ranges (e.g., a goal weight range of between 140-150 pounds).

In another embodiment, the receiving component 220 is configured to receive monitoring information that includes reference values associated with the health metrics to be monitored for a patient. Such reference values may be used to determine a criticality of the health metric. Such reference values also may be used to determine when an alert must be sent to a healthcare provider. In one embodiment, these values may include default values that are based on nationally-recognized standards or clinical guidelines. Default values may be extracted and received from the data store 204.

In another embodiment, the reference values may be customized by a healthcare provider and selected from within a patient profile. For example, a healthcare provider may want to monitor a patient's blood glucose levels. He/she may set critical high ranges at above 300 mg/dL, critical low levels at below 60 mg/dL, uncontrolled values at greater than 200 mg/dL and controlled levels at values between the critical low and uncontrolled values. These reference values can be used to determine the criticality (e.g., critical, uncontrolled or controlled) of the received health metric information, as described below.

The terms “critical”, “uncontrolled” and “controlled” are merely exemplary. By way of illustration, a critical value generally describes a value that will have a negative impact on the patient's health if not addressed in a timely manner. Non-critical values, such as uncontrolled values, can be defined as values that generally do not negatively impact the patient's health if not addressed in a timely manner. Controlled and uncontrolled values are non-critical values, but uncontrolled values may pose a greater risk to a patient's health than controlled values, especially when left untreated. Additionally, controlled values may not need to be addressed at all, whereas uncontrolled values may indicate that a patient needs to be placed on a watch list. A watch list, for example, may be stored in the data store 204 and contain the name of all patients with a majority (i.e., greater than 50%) of received values for a particular health metric falling within an uncontrolled range. The criticality classifications, however, may be different from those described herein. It is contemplated that any number of criticality classifications may be created, stored and/or used to describe the value of a health metric.

As well, the receiving component 220 is configured to receive health metric information. Such information may include numerical values received from the remote monitoring devices. Such devices are numerous and well-known in the art but representative examples may include pulse oximeters, blood pressure monitors, blood glucose monitors, heart rate/rhythm monitors, scales, pedometers, sensors affixed to canes or walkers for monitoring patient location, gait, linear acceleration, and the like. Data from medical devices may include waveform tracings, numerical values, qualitative descriptions, and the like. The devices may communicate with the receiving component 220 using Wi-Fi, iOS devices, Bluetooth, Internet (LAN or WAN) or other similar technologies known in the art. The data is securely-transmitted via secure communication lines, authentication, encryption methods, and the like. The receiving component 220 may also receive patient-identifying information from, for example, the data store 204. In addition, the health metric information may include an indication of when a measurement was taken.

In one embodiment, the receiving component 220 may receive health metric information from, for example, a patient, a healthcare provider, or other third person. Such information may be manually inputted into a patient profile for the patient. The health metric information may include quantitative information (e.g., numerical values) or qualitative information (e.g., “elevated” blood pressure) associated with a health metric. Therefore, if a remote monitoring device breaks, is otherwise unable to communicate with the receiving component 220, or is generally unavailable to the patient, the patient, healthcare provider, or other third person(s) may still keep a record of the patient's health metric information. For example, if a patient's WiFi weight scale breaks, the patient can measure his/her health metric weight information on a non-WiFi weight scale and enter the information into his/her patient profile using a keyboard connected to/associated with the computing device 208.

The receiving component 220 is also configured to receive or access information related to alerting protocols. Such information might include identifying information about persons that should receive an alert when a patient's health metric reaches a predefined criticality. Such information might also include the order in which healthcare providers or family members receive an alert. The information might also include instructions for communicating an alert based solely on the criticality of the health metric or the type of health metric. Additionally, information including, for example, pager numbers, telephone numbers, email addresses, and types of devices associated with persons that receive an alert may also be received by the receiving component 220. Moreover, alert information might additionally include alert protocols or algorithms for sending alerts. The algorithms and protocols may be specified by a user of the patient profile or be based on clinical guidelines and standardized recommendations, or the like.

The receiving component 220 can also receive information indicating that an alert was received and acted upon by a healthcare provider. Such information might include a healthcare provider's acceptance or rejection of the alert within a patient profile. For example, a healthcare provider may select an icon to snooze or turn off the alert. Additionally, a healthcare provider may accept an alert, indicating that the same alert does not need to be sent to a different healthcare provider. The information might also include documentation that is responsive to the alert or relates to the health metric information that triggered the alert. The documentation might include, for example, clinical orders, medication orders, tasks, clinical notes, orders, summaries, reports, and analyses describing an action taken in response to receiving an alert or a future course of treatment.

The determining component 222 is configured to use the information received by the receiving component 220 to determine the criticality of health metrics. As described above, the receiving component 220 is configured to receive reference values and/or ranges for health metrics. These values may be default values stored in the data store 204 or values inputted by healthcare providers from within a patient profile. As the receiving component 220 receives information about a health metric from one of the remote monitoring devices described above, the determining component 222 compares the received information to the predefined and/or stored criticality information for that type of health metric for the patient. Depending on which of the criticality ranges the received information falls within, a criticality level is determined for the patient's health metric. For example, a healthcare provider might set a critical high and critical low value for systolic blood pressure at greater than 160 and lower than 90, respectively. If a patient's received systolic blood pressure value is 165, the determining component 222 will determine that the systolic blood pressure of the patient is critical. Thus, more than one value (e.g., a systolic and diastolic value) may contribute to a determination of the criticality of a health metric.

In one aspect, the determining component 222 determines that a healthcare provider has not responded to an alert. Upon making such a determination, the determining component 222 can also determine that the same or a more urgent alert should be sent to the same or a different healthcare provider. The determining component 222 makes such a determination utilizing the alert information received at the receiving component 220.

The determining component 222 is also configured to monitor and determine the progress of the patient toward reaching a goal value for a health metric. In one aspect, the progress of the patient may be determined according to a particular time frame, such as the progress of a patient in losing 10 pounds over a one-month period. The progress may also be determined based on comparing the health metric information values received for the patient to a goal value. Similarly, the progress may be determined based on the length of time during which a patient has maintained a goal value. It will be understood, however, that the progress of a patient toward reaching a goal value may be determined in any number of ways and the examples provided are not meant to be limiting.

In another aspect, the determining component 222 recognizes variances and discerns trends based on the health metric information received at the receiving component 220. For instance, the determining component 222 is configured to determine that newly-received health metric information is statistically significantly different from historical values associated with the received health metric. The determining component 222 may determine that an alert should be communicated to a healthcare provider associated with the patient because values measured for a health metric are extremely variable. Additionally, the determining component 222 is configured to determine that certain health metric variances are normal for a patient. For example, the system can determine that a diabetic patient's drop in a blood sugar health metric value is within a normal variance for the patient, but still generate an alert advising the patient to re-measure his blood sugar soon after receiving an insulin injection.

The determining component 222 recognizes variances, in part, by first discerning trends typically associated with the patient. For instance, if every morning a patient walks 1000 steps, the determining component 222 will recognize this trend and consider it a “normal” value for the patient. In addition, the determining component 222 can recognize trends on a more granular level. For example, the determining component 222 might determine that between the hours of 5-7 PM every day, a patient takes about three times as many steps as between the hours of 8-10 AM. Such trend data may be used to determine that a patient has varied from a trend (e.g., yesterday and today the patient walked about the same number of steps between 5-7 PM and 8-10 AM) and also to determine that an alert describing the variance should be sent to a family member of the patient, a healthcare provider, or the like. These trends and variances may be determined based on algorithms and statistical methods.

The assigning component 224 assigns a health alert status to every health metric that a patient is monitoring. Any number of health alert statuses may be employed based on the type of health metric being monitored. Exemplary health alert statuses might include terms or symbols designating health metrics as “controlled,” “uncontrolled,” “critical,” and “non-compliant”. An uncontrolled health alert status indicates that for a specified time period, the values received for the health metric fell into an uncontrolled range. For example, if a majority of a patient's blood glucose levels are uncontrolled for a week, the patient may be assigned an uncontrolled health alert status for her blood sugar health metric. A majority may generally be defined as over fifty percent. In another aspect, a critical health alert status may be assigned if the most recent value received for the health metric fell into a critical range. In yet another aspect, a non-compliant health alert status indicates that a selected or default number of items of information related to a health metric have not been received during a predefined monitoring period. In still another aspect, a controlled health alert status may be assigned when the health metric does not fall within one of the critical, uncontrolled or non-compliant health alert status categories.

In one aspect, the health alert statuses are displayed together in a graphical user interface (GUI). The alert statuses may include distinguishing shapes, colors, symbols, and the like. For example, a critical health alert status may be indicated by a red circle, whereas a non-compliant health alert status may be represented by a question mark. The heath alert statuses may be viewed within each patient profile and/or compiled in an alert status dashboard. The alert status dashboard presents a compilation of patient data that is monitored by a particular healthcare provider. The display of the health alert statuses in one location facilitates quick and easy viewing by healthcare providers.

The communicating component 226 is configured to communicate health metric alert information to a patient profile. The communicating component 226 is also configured to communicate alerts to electronic communication devices associated with persons selected or determined to receive alerts. The alert information may include the health alert status associated with the alert (e.g., critical, uncontrolled, or non-compliant), the type of health metric, the value of the health metric, patient-identifying information, and the like. In one aspect, the health metric is related to the alert if the received health metric information triggered the alert.

In one embodiment, the communicating component 226 communicates the alert initially to a primary healthcare provider associated with the patient. The primary healthcare provider may be a health coach that monitors multiple health metrics for multiple patients. If the primary healthcare provider does not respond to, snoozes, or rejects the alert, the communicating component 222 may communicate the alert information to an electronic communication device associated with a secondary healthcare provider, such as, for example, the patient's primary care physician or a specialist. If the secondary healthcare provider does not respond to, snoozes, or rejects the alert, for example, the alert may be communicated to every healthcare provider associated with the patient. The hierarchical order for communicating alerts may be predetermined, for example, by any person with access to the patient profile.

In another embodiment, the communicating component 222 determines the healthcare provider role best suited to initially address the particular patient alert, and communicates the alert information to healthcare providers in that role. By way of illustrative example, an alert might indicate that a patient's blood pressure has dropped to below critical levels. The communicating component 222 may determine that the patient's primary care physician and/or the patient's cardiologist should receive an alert. Such a determination could be made automatically based on a set of rules. Or, as noted above, one or more users of the remote patient monitoring system 206 can preselect providers to respond to a specific type of health metric alert.

The communicating component 222 is also configured to receive information that a healthcare provider has responded to, turned off, failed to respond to, or provided documentation relevant to the alert. The communicating component 222 can extract the documentation and communicate the documentation to an EMR associated with the patient. In addition, the documentation and/or response may be communicated in association with the health metric information that triggered the alert. For example, a graph illustrating a spike in a patient's blood pressure may be communicated to an EMR along with a medication order for a new blood pressure medication.

In yet another embodiment, the communicating component 222 is configured to communicate an alert to patients, family members of patients, or any other suitable individual preselected from within the patient profile, all of which may be collectively referred to herein as “interested parties.” Identifying information, including contact information (e.g., cell phone numbers, pager numbers, email addresses), for the interested parties may be extracted from the data store 204, for example. As well, alerts may be communicated to interested parties based on the type of health metric, the criticality of the metric, a predetermined hierarchy for sending alerts, and the like. For example, a patient's daughter might be alerted only if the patient is non-compliant in measuring her blood pressure for a period of at least three days.

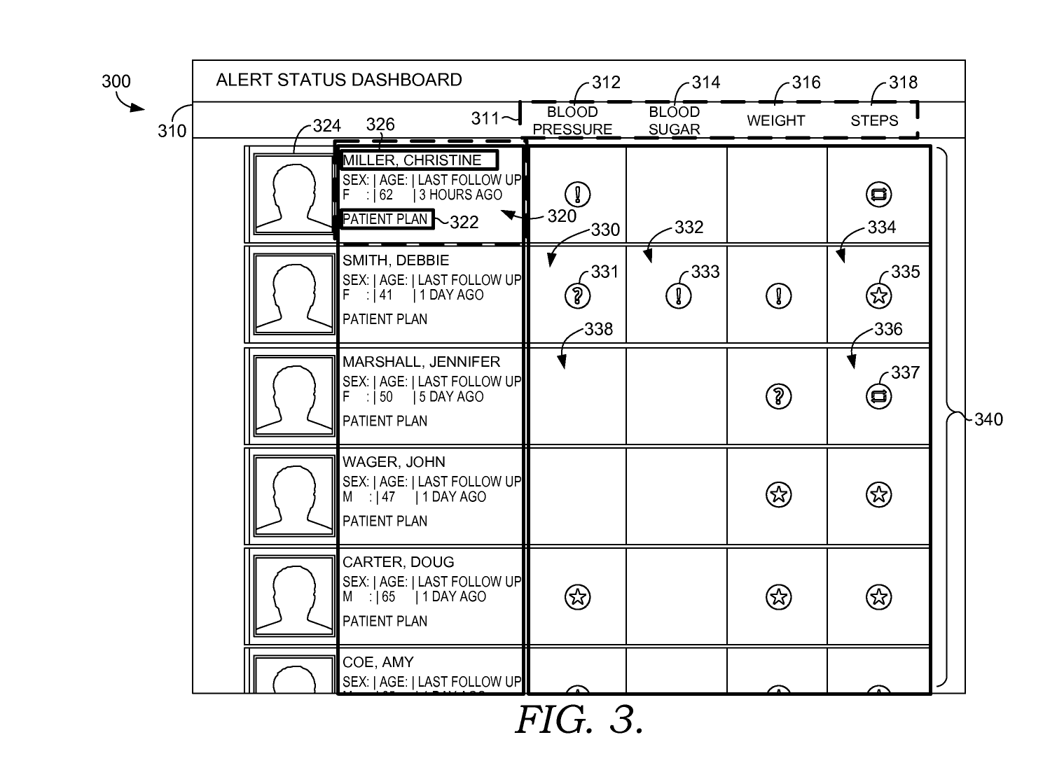

Turning now to FIG. 3, an exemplary graphical user interface (GUI) 300 is depicted for presenting health alert statuses for a plurality of health metrics. The GUI 300 is presented when a healthcare provider logs in to a remote patient monitoring system, such as the remote patient monitoring system 206 of FIG. 2. The alert status dashboard 310 includes health alert status information for a plurality of patients. As described above, a health alert status is assigned to each health metric for a patient based on the criticality of the health metric. Additionally, patient-identifying information is presented for each of the plurality of patients. For example, patient 324 has patient-identifying information 320. The patient-identifying information 320 includes, for example, a patient name 326, gender, age, last follow up, and a selectable patient plan icon 322. In addition, for easy identification, a picture of the patient 324 may be provided. Upon selecting the patient plan icon 322 or the name 326 of the patient 324, more detailed information about the patient 324 may be presented in a separate GUI.

Health metrics 311 are presented on the alert status dashboard 310. The alert status dashboard 310 presents multiple health alert statuses for each patient a healthcare provider is monitoring. Health metric identifiers 311 may be presented in association with a chart 340. The health metric identifiers 311 are labeled according to the health metric to which they correspond. For instance, the identifiers 312, 314, 316, and 318 correspond to “blood pressure,” “blood sugar,” “weight,” and “steps” health metrics, respectively. The chart 340 displays the health alert statuses. These alert statuses may include different symbols, shapes, shading, and/or colors to make it easier for healthcare providers to distinguish between critical and non-critical alert statuses. For example, the alert status area 330 includes a question mark 331 that might indicate that a patient has been non-compliant in measuring her blood pressure. The exclamation point icon 333 of alert status area 332 may indicate a critical blood sugar reading. Likewise, alert status area 334, which includes a star icon 335, may indicate that patient Debbie Smith's “steps” are controlled, whereas alert status area 336, which includes a reverse arrows icon 337, might signify that patient Jennifer Marshall's “steps” are uncontrolled. The blank alert status area 338 may indicate that the patient is not required or has not been requested to measure the representative health metric (e.g., blood pressure).

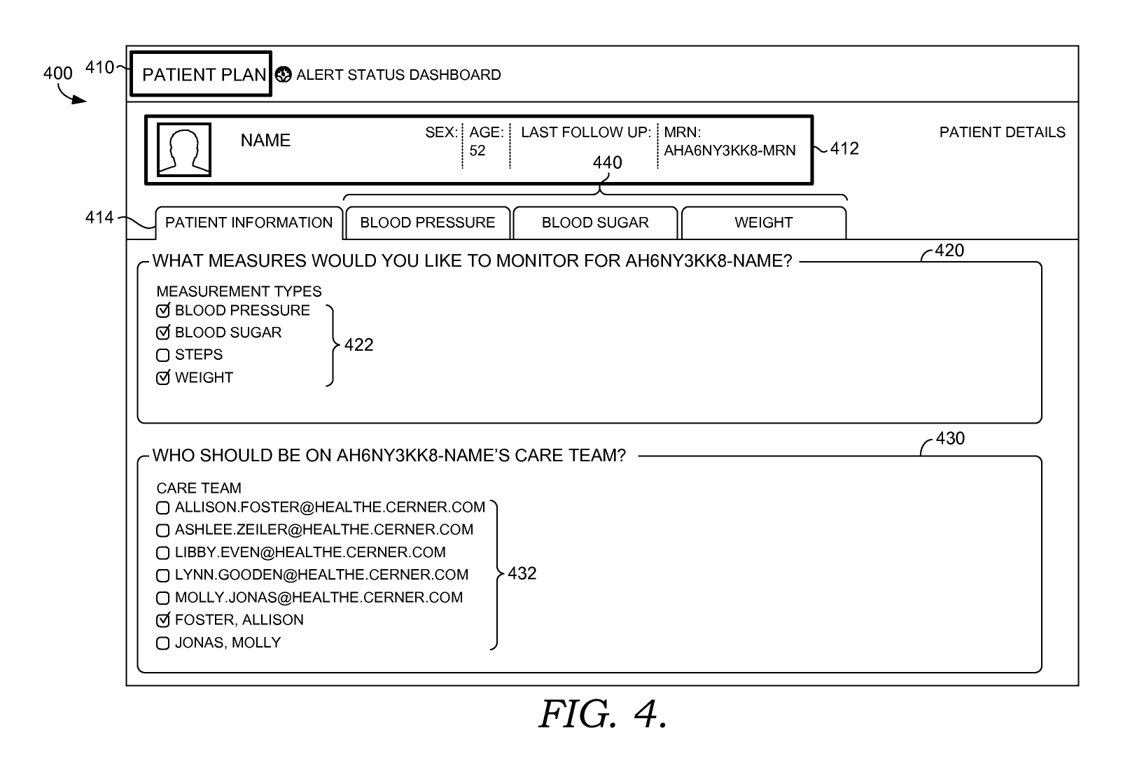

Turning to FIG. 4, FIG. 4 depicts an exemplary GUI 400 illustrating selectable patient information within a patient plan. The GUI 400 may be presented when a healthcare provider or other user selects the patient plan icon 322 of FIG. 3. The GUI 400 includes a patient plan 410 associated with a patient and a patient information tab 414. The GUI 400 further includes patient-identifying information 412 for the patient. As well, the GUI 400 includes health metric tabs 440 that may be selected from within GUI 400 to present more detailed information about the health metrics being monitored for the patient.

When selected, the patient information tab 414 presents selectable information for monitoring a patient's health metrics. For example, the GUI 400 includes a health metric monitoring area 420. Health metrics 422 (i.e., “health metrics”) within the health metric monitoring area 420 may be selected for monitoring. As shown, a checked box adjacent to a health metric 422 indicates selection of the health metric 422. Individual health metrics can be selected by tapping, gesturing, hovering and clicking, or using any other technique known in the art. Selecting health metrics 422 allows healthcare providers to customize the health metric information and alerts they receive. For example, a healthcare provider can select the type of health metrics 422 to monitor by checking the box next to each of the health metrics 422 he/she wants to monitor for a patient. After selecting the blood pressure, blood sugar and weight health metrics 422 in the health metric monitoring area 420, the healthcare provider will receive health metric information and alerts pertaining to only those selected health metrics 422.

In addition, the patient's care team can be selected at care team area 430. The care team area 430 may include selected caregivers 432 that will receive an alert when one of the health metrics 422 reaches a predefined level of criticality. The caregivers 432 are selected using the same techniques as those described above with respect to the health metrics 422. The health metrics 422 and the caregivers 432 are merely exemplary, and any number of health metrics or caregivers can be respectively monitored and selected.

Although not shown, when selected, the patient information tab 414 may present other selectable information/icons. For instance, the patient information tab 414 could include selectable alert protocol information, such as an order for distributing alerts based on the criticality of a health metric. As well, similar patient plan 410 interfaces may be accessible to patients, family members, or other interested persons consented to by the patient. If similar interfaces are made available and presented to patients, family members, or other interested persons, they can be viewed only in a read-only format. Patients, family members, or other interested persons cannot modify the health metrics 422 or the caregivers 432 already selected by a healthcare provider.

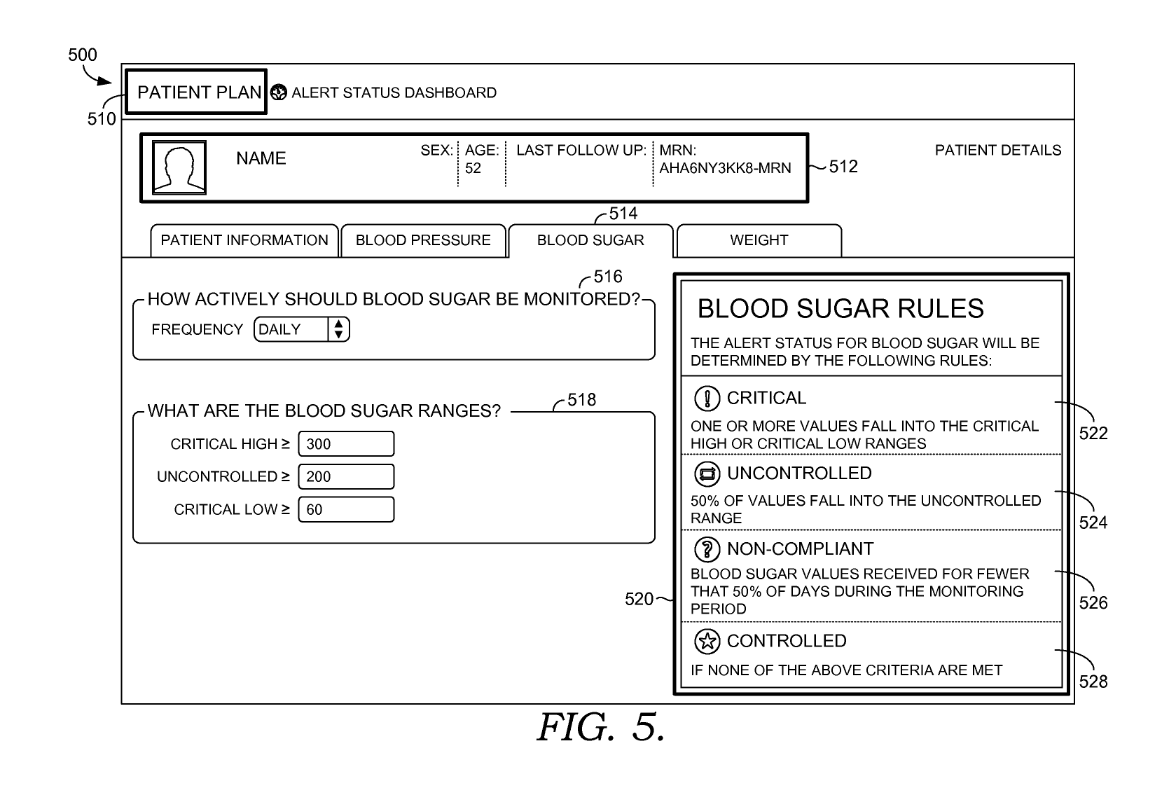

Turning to FIG. 5, FIG. 5 depicts an exemplary GUI 500 for selecting the frequency and baseline criticality ranges for a health metric, such as one of the health metrics 422 of FIG. 4. The GUI 500 may be presented when a user of the GUI 400 selects one of the exemplary health metrics tabs 440 of GUI 400. Included within the GUI 500 is patient-identifying information 512. GUI 500 also includes a selected health metric tab 514 (“blood sugar”), an associated monitoring frequency area 516, and an associated reference value area 518. The monitoring frequency area 516 allows a provider to select a frequency at which the health metric, for example, blood sugar, is monitored.

A provider can also customize the reference values used to determine the criticality of a patient's health metrics at the reference value area 518. Although not shown, a similar patient plan 510 could be presented for each of a plurality of patients the healthcare provider is monitoring. The reference values in the reference value area 518 can be adjusted for each patient and each type of health metric. Values are adjusted by deleting the values shown and inputting or selecting new values from a drop-down menu (also not shown). Also, default values may be presented in reference value area 518.

Although not shown, it is also contemplated that other selectable information for a health metric might be presented in GUI 500. Such information might include alert information, goal values for a health metric, periods for determining trends or variances, and the like. The GUI 500 also presents a rules box 520 that explains a basis for assigning health alert statuses to a health metric. The alert boxes 522, 524, 526, and 528 define the health alert status symbols for the health metric.

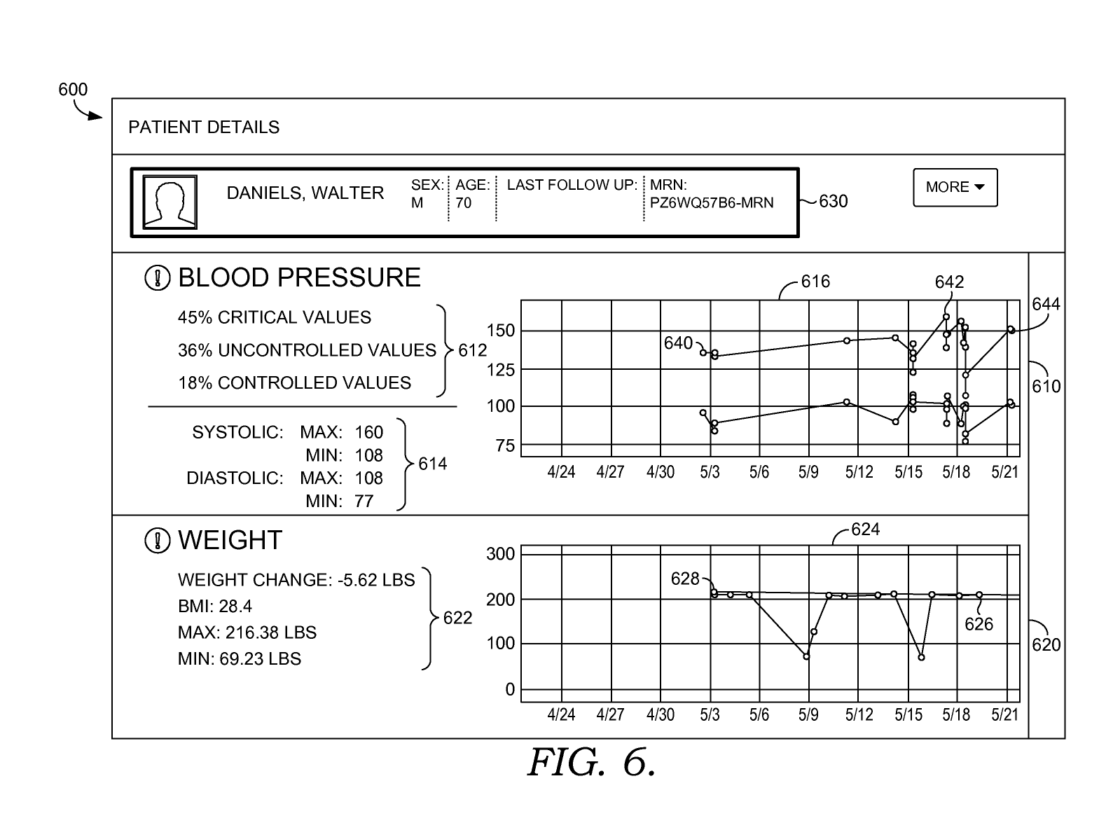

FIG. 6 depicts an exemplary GUI 600 that is presented to a user of the remote patient monitoring system upon selection of a patient, such as selection of the patient 324 of FIG. 3. The GUI 600 displays received information for two different health metrics, blood pressure and weight. Although not shown, it is contemplated that GUI 600 could display data for more than two different health metrics, including health metrics other than the exemplary blood pressure and weight health metrics shown. GUI 600 includes patient-identifying information 630. Additionally, GUI 600 includes a blood pressure health metric area 610 and a weight health metric area 620. In the blood pressure health metric area 610, a criticality summary 612 is presented along with minimum and maximum values 614 for each of the systolic and diastolic blood pressure readings.

The blood pressure health metric graph 616 includes a series of data points representing blood pressure values that were measured by a remote monitoring device (e.g., blood pressure cuff) associated with the exemplary patient, Walter Daniels. In one aspect, the values 640, 642 and 644 may be distinguished based on their determined criticalities. For example, if value 640 represents a “controlled” value for a blood pressure health metric, the circle that represents the value 640 may be color-coded green. Likewise, the value 642 might indicate a critical value, so the circle that represents the value 642 may be color-coded red. Although not shown, in some embodiments, a user may zoom in and select the data points. As well, if a data point is selected, information about the data point, such as the health metric value it represents, may be presented in an enlarged or summarized form. Other markers may be used to distinguish the discrete data points on the blood pressure health metric graph 616 such as symbols, shapes, shading, or the like.

The GUI 600 also presents information for another exemplary health metric, weight. The weigh health metric graph 624 includes a series of data points, representing blood pressure values that were measured by a remote monitoring device (e.g., Withings scale) associated with the patient, Walter Daniels. As shown, the weight health metric area 620 presents slightly-varied information from the blood pressure health metric area 610. For instance, summarized information 622 still includes minimum and maximum values for the health metric, but the summarized information 622 also includes BMI and weight change values. These values may be reported by the remote monitoring device or calculated based on the raw data points received from the remote monitoring device. For instance, weight change may automatically be calculated by subtracting the most recent weight value (e.g., value 626) from the earliest-monitored weight value (e.g., value 628). The information presented on the GUI 600 may be updated in real-time as updated information becomes available. For example, if the patient, Walter Daniels, measures his blood pressure using a blood pressure cuff, this data will be instantly available on the blood pressure health metric graph 616 when received from the blood pressure cuff at a receiving component, such as the receiving component 220 of FIG. 2.

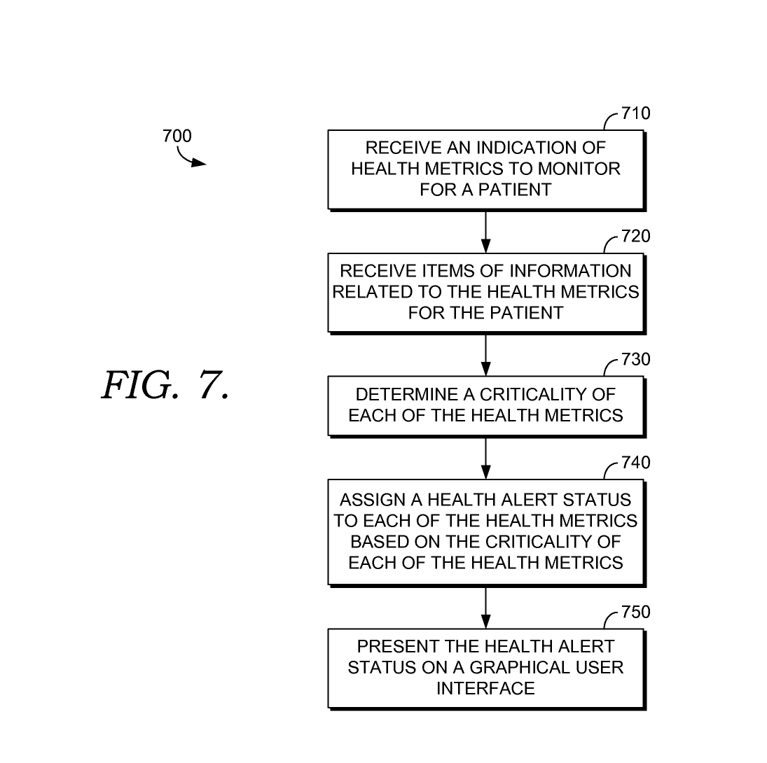

Turning now to FIG. 7, FIG. 7 depicts a flow diagram of an exemplary method 700 of remotely monitoring and assigning a health alert status to health metrics for a patient. The method may be carried out by a remote patient monitoring system such as the remote monitoring system 206 of FIG. 2. At a step 710, an indication of health metrics to be monitored for a patient is received, such as the information received at the receiving component 222 of FIG. 2. Exemplary information might include customized information for a patient such as the number and type of health metrics to monitor, goal values for a health metric, and a frequency for monitoring one or more health metrics. Thus, while the step 710 references only one patient, it will be understand that information can be received for any number of patients and any number of associated health metrics. The indication may be received from a user logged in to a patient profile. The desired health metrics may be selected by a healthcare provider from within a patient profile, such as from the health metric monitoring area 420 of FIG. 4.

At a step 720, health metric information is received. In one aspect, the information may come from remote monitoring devices that are communicatively coupled to the remote patient monitoring system, such as the remote patient monitoring system 206 of FIG. 2. Patients can register remote monitoring devices from within their patient profile. After registration, automatic, real-time health metric readings are provided to the remote patient monitoring system whenever a remote monitoring device (e.g., blood pressure cuff, Withings scale, etc.) communicates a reading for a given health metric. In another aspect, the information may be manually inputted by a patient or a provider into a patient profile of the remote patient monitoring system.

At a step 730, the criticality of the health metrics is determined based on the information associated with each of the health metrics falling within one of the predetermined criticality ranges for the health metric. Criticality can also be determined based on a variance of a health metric value from normal or trending values for the health metric. The predetermined value ranges that define a criticality for each health metric may be set by a healthcare provider. If set by a healthcare provider, the predetermined criticality could be based on factors such as the patient's age, gender, race, disease factors, familial or genetic histories, comorbidities, and the like. The predetermined value ranges may, in other embodiments, include default values, such as medically-accepted normal and abnormal values for the health metric. By way of illustrative example, a patient profile may indicate that a patient has walked about 6,000 steps every day for a month. If the patient's “steps” measurements fall to 2,000 steps per day, the remote patient monitoring system may determine that the criticality of the “steps” health metric is critical. Similarly, if a patient is compliant in measuring his/her blood sugar health metric every day, and is non-compliant (i.e., fails to measure) in measuring his/her blood sugar for two days in a row, the system might determine that the criticality of the patient's “blood sugar” health metric is critical.

At a step 740, a separate health alert status is assigned to each of the health metrics for the patient. The health alert status is based on the determined criticality of the health metric. Exemplary health alert statuses may include “controlled,” “uncontrolled,” “critical,” or “non-compliant.” However, these health alert status classifications are not meant to be limiting, and it will be understand that other classifications can be used. At a step 750, the health alert status is presented on a GUI. Although not shown, other steps of the exemplary method 700 might include storing the received health metric information, the criticality of the health metrics, and the health alert statuses in a data store.

Additionally, other embodiments of the exemplary method 700 might include creating and storing an escalation tree that includes an order for distributing alerts. A first alert might be communicated to a first provider, indicating that a health metric for a patient has reached a predefined level of criticality (e.g., a “critical” level) . If the first provider does not acknowledge receipt of the first alert, a determination will be made that the alert must be sent to at least a second provider, and the first alert will subsequently be communicated to at least a second provider. Additionally, more elaborate escalation trees are contemplated as being part of the present invention. For instance, multiple providers may receive an alert simultaneously. In another aspect, a provider may receive alerts based on the provider's role being well suited to address the criticality or type of a health metric. Additionally, some providers may receive an alert based on the degree of criticality of the health metric. For example, if a health coach is normally the first healthcare provider to receive an alert, it may be determined that the patient's primary care physician and/or cardiologist should receive a first alert when the patient's blood pressure drops to dangerously low levels.

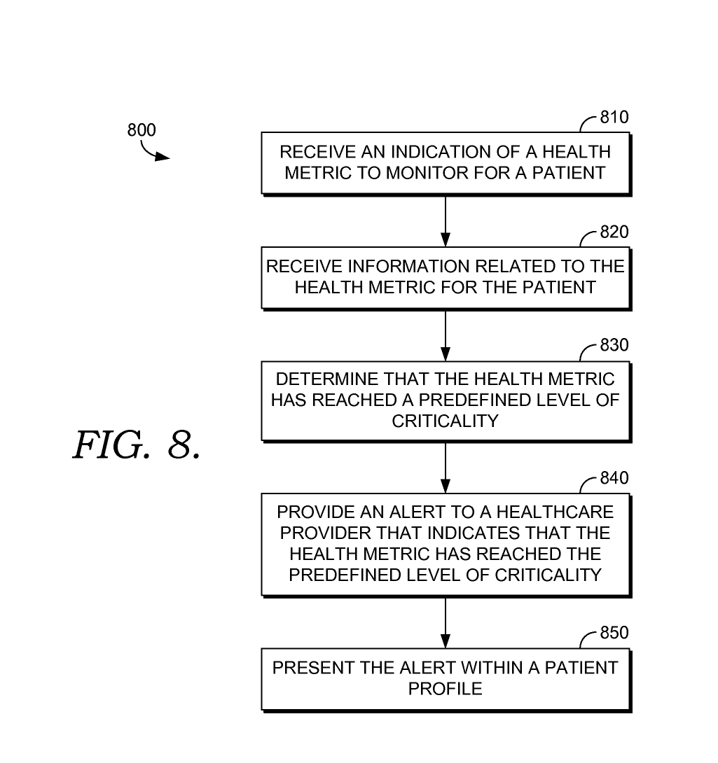

Turning to FIG. 8, FIG. 8 depicts a method of communicating an alert to a healthcare provider when a patient's remotely-monitored health metric reaches a predefined level of criticality. Although not shown, a predefined level of criticality (e.g., “critical”) may be indicated by the received health information falling within the “critical” reference value ranges for that health metric. For example, a healthcare provider might input specify from within the patient profile that all blood glucose readings measuring above 300 mg/dL are critical. At a step 810, an indication of a health metric to be monitored for the patient is received. At a step 820, information that relates to the health metric is received. The information may be manually inputted by a user into a GUI of the patient profile or received from a remote monitoring device.

At a step 830, it is determined that the health metric has reached a predefined level of criticality. The determination is made based on the information that relates to the health metric falling within a predetermined criticality range for the health metric. At a step 840, an alert is communicated to at least one healthcare provider, indicating that the health metric has reached a defined criticality. The alert may take many forms, including, for example, textual messages, visual or audio displays, a phone call, or the like. The alert may include patient-identifying information, the criticality of the health metric, a type of health metric, a value for the health metric, a time the health metric was measured, and the like. At a step 850, the alert, or a representation of the alert, may be presented within a patient profile associated with the patient.

The method 800 may be continued further. A response to the alert may be received. The response may include turning off or snoozing the alert within the patient profile, providing documentation in the patient profile and/or a patient's electronic medical record, indicating that a different healthcare provider should be contacted, or the like. Written responses or documentation can be stored in association with the received information that relates to the health metric.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer storage media having computer-executable instructions embodied thereon that, when executed by a computing device, perform a method of remotely monitoring one or more health metrics for a patient, the method comprising:
receiving an indication of the one or more health metrics to be monitored for the patient;
receiving items of information related to the one or more health metrics;
determining a criticality of each of the one or more health metrics based on the items of information associated with the each of the one or more health metrics falling within a predetermined value range for the each of the one or more health metrics, wherein the predetermined value range is associated with a predefined criticality for the each of the one or more health metrics;
assigning a health alert status to the each of the one or more health metrics based on the determined criticality of the each of the one or more health metrics; and
presenting a representation of the health alert status for at least one of the one or more health metrics on a graphical user interface (GUI).

2. The media of claim 1, further comprising:
communicating a first alert to at least a first provider, the first alert indicating that one of the one more health metrics for the patient has reached a critical level;
determining that the at least the first healthcare provider has not acknowledged receipt of the first alert; and
in response to determining that the at least the first provider has not acknowledged receipt of the first alert, communicating the first alert to at least a second provider.

3. The media of claim 1, further comprising:
displaying the items of information that relate to the one of the one or more health metrics in a graphical form; and
storing the items of information in a patient profile associated with the patient.

4. The media of claim 3, wherein the patient profile is integrated into an electronic medical record (EMR) associated with the patient.

5. The media of claim 1, wherein the one or more health metrics comprise one or more selected from the following: blood pressure, blood sugar, weight, or steps.

6. The media of claim 1, wherein the health alert status for the each of the one or more health metrics comprises at least one of the following:
critical, wherein a critical alert status indicates that the items of information associated with the each of the one or more health metrics fall within a predetermined critical range,
uncontrolled, wherein an uncontrolled alert status indicates that a majority of the items of information associated with the each of the one or more health metrics fall within a predetermined uncontrolled range,
non-compliant, wherein a non-compliant alert status indicates that a predetermined number of the items of information associated with the each of the one or more health metrics have not been received during a monitoring period, and
controlled, wherein a controlled alert status indicates that the items of information associated with the each of the one or more health metrics do not fall within the critical, uncontrolled or non-compliant categories.

7. The media of claim 6, further comprising creating a watch list that includes information associated with the patient that is assigned an uncontrolled health alert status for at least one of the one or more health metrics monitored for the patient.

8. The media of claim 1, further comprising:
receiving at least one goal value for at least one health metric of the one or more health metrics; and
monitoring the progression of the patient toward the at least one goal value.

9. The media of claim 8, further comprising notifying one or more healthcare providers associated with the patient about the progression of the patient toward the at least one goal value.

10. The media of claim 1, wherein the items of information related to the one or more health metrics is received from one or more devices.

11. The media of claim 1, further comprising:
determining trends for the items of information related to the one or more health metrics for the patient; and
displaying the trends on a GUI.

12. One or more computer storage media having computer-executable instructions embodied thereon that, when executed by a computing device, perform a method of alerting one or more healthcare providers about a criticality of at least one health metric for a patient, the method comprising:
receiving from a provider an indication of the at least one health metric to be monitored for the patient;
receiving information that relates to the at least one health metric;
determining that the at least one health metric has reached a predefined level of criticality based on the received information falling within a predetermined range of values for the at least one health metric, wherein the predetermined range of values is associated with a predefined criticality for the at least one health metric;
communicating at least one alert to one or more healthcare providers, the at least one alert indicating that the at least one health metric has reached the predefined level of criticality; and
presenting a representation of the at least one alert within a patient profile associated with the patient.

13. The media of claim 12, further comprising:
receiving information that indicates that the one or more healthcare providers took at least one action in response to receiving the alert;
associating the at least one action with the information that relates to the at least one health metric; and
storing the association in the patient profile.

14. The media of claim 12, wherein the information that relates to the at least one health metric comprises one or more numerical values, and wherein the alert indicates that the one or more numerical values has a statistically significant variance from historical values received for the at least one health metric for the patient.

15. The media of claim 12, wherein the alert is provided to one or more electronic communication devices associated with each of the one or more healthcare providers.

16. The media of claim 12, wherein the patient can select from within the patient profile the one or more healthcare providers that receive an alert when the at least one health metric reaches a predefined level of criticality.

17. The media of claim 12, further comprising:
receiving, in response to providing the at least one alert, documentation from the one or more healthcare providers, wherein the documentation is related to the content of the alert; and
storing the documentation in the patient profile.

18. The media of claim 12, wherein one of the one or more healthcare providers predetermines a set of criticality ranges for the at least one health metric.

19. A computer-storage medium having stored thereon instructions, executable by a computing device, for a remote patient monitoring user interface for monitoring one or more health metrics for a patient, the remote patient monitoring user interface comprising:
a patient identification area that presents an identity of the patient;
a monitoring area configured to receive a user selection of the one or more health metrics to monitor for the patient;
a care team area configured to receive a user selection of one or more providers to receive information about the one or more health metrics selected to be monitored for the patient;
a health metric area configured to receive a user selection of a tab representing additional information related to at least one of the one or more health metrics, and wherein upon receiving the user selection of the tab, additional information related to the at least one health metric is presented in at least a separate user interface.

20. The media of claim 19, wherein the at least the separate user interface is configured to present items of information related to the at least one health metric in a graphical form.
